(19) United States
(12) Patent Application Publication
(10) Pub. No.: US 2010/0294077 A1
(43) Pub. Date: Nov. 25, 2010

(54) DEVICE FOR CONTROLLING A MOTORCYCLE THROTTLE LOCK

(76) Inventor: John S. Odendaal, Calgary (CA)

Correspondence Address: L.C. Begin & Associates, PLLC, 510 Highland Avenue, PMB 403, Milford, MI, 48381, US

(21) Appl. No.: 12/780,249

(22) Filed: May 14, 2010

Related U.S. Application Data
(60) Provisional application No. 61/178,087, filed on May 14, 2009.

(51) Int. Cl. G05G 1/10

(52) U.S. Cl. 74/543

(57) ABSTRACT

One embodiment of a device for operating a motorcycle throttle lock includes a body member configured for engaging a portion of the motorcycle throttle lock. A handle member extends from the body member. The handle member is configured for manipulation by a user to adjust the portion of the motorcycle throttle lock engaged with the body portion to at least one of a first operational mode and a second operational mode.

### CROSS REFERENCE TO RELATED APPLICATION

This application claims the benefit of U.S. Provisional Application No. 61/178,087 filed on May 14, 2009, the disclosure of which is incorporated by reference.

### FIELD OF THE INVENTION

The present disclosure generally relates to a motorcycle throttle lock and more specifically to a device for operating a motorcycle throttle lock with ease and in a user-friendly manner.

### BACKGROUND OF THE INVENTION

A motorcycle throttle lock (also known as a “cruise control”) is adapted to fix the hand grip throttle of a motorcycle in a desired position. The motorcycle throttle lock is configured to hold the hand grip throttle of the motorcycle at a selected position against a force exerted by an internal spring that biases the hand grip throttle toward a neutral position. Certain designs of the motorcycle throttle lock employ a lock screw for locking the hand grip throttle at the selected position.

Throttle lock designs employing a lock screw require a motorcyclist to screw in the lock screw in order to lock the hand grip throttle and/or retract the lock screw whenever the hand grip throttle has to be released. This results in a very cumbersome operation due to the small size and shape of the lock screw. Additionally, when it is desired to urgently to release hand grip throttle, the motorcyclist may be unable to respond as quickly, thereby increasing danger of accidents. Also, the locking member may be difficult to manipulate when the motorcyclist is wearing gloves.

### SUMMARY OF THE INVENTION

In one aspect of the embodiments of the present invention, a device for operating a motorcycle throttle lock includes a body member configured for engaging a portion of the motorcycle throttle lock. A handle member extends from the body member. The handle member is configured for manipulation by a user to adjust the portion of the motorcycle throttle lock engaged with the body portion to at least one of a first operational mode and a second operational mode.

### BRIEF DESCRIPTION OF THE DRAWINGS

The advantages and features of the present disclosure will become better understood with reference to the following detailed description and claims taken in conjunction with the accompanying drawings, in which:

FIG. 1 is a front perspective view of one embodiment of a device for operating a motorcycle throttle lock;

FIG. 2 is a side perspective view of the device of FIG. 1;

FIG. 3 is a perspective view of a lock screw of a motorcycle throttle lock partially received in the device of FIG. 1; and

FIG. 4 is an environment in which the device of FIG. 1 may be utilized on the lock screw of the motorcycle throttle lock.

Like reference numerals refer to like parts throughout the description of the drawings.

### DETAILED DESCRIPTION OF THE INVENTION

The exemplary embodiments described herein detail for illustrative purposes are subject to many variations in structure and design. It should be emphasized, however, that the present disclosure is not limited to a particular device for operating a motorcycle throttle lock in a motorcycle, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms, “first,” “second,” and the like, herein do not denote any order, elevation or importance, but rather are used to distinguish placement of one element over another. The terms “a” and “an” herein do not denote a limitation of quantity, but rather denote the presence of at least one of the referenced item. The use of terms “including,” “comprising,” or “having” and variations thereof herein is meant to encompass the items listed thereafter and equivalents thereof as well as additional items.

The term ‘motorcycle throttle lock’ herein relates to a locking mechanism configured to lock a hand grip throttle of a motorcycle for maintaining a steady throttle opening over an extended period of time. The motorcycle throttle lock includes a lock screw adapted to be operated for locking and unlocking the hand grip throttle. Typically, the lock screw may be a circular structure having a plurality of aims. The plurality of arms provides the gripping portion for maneuvering the lock screw, and, in turn, the motorcycle throttle lock.

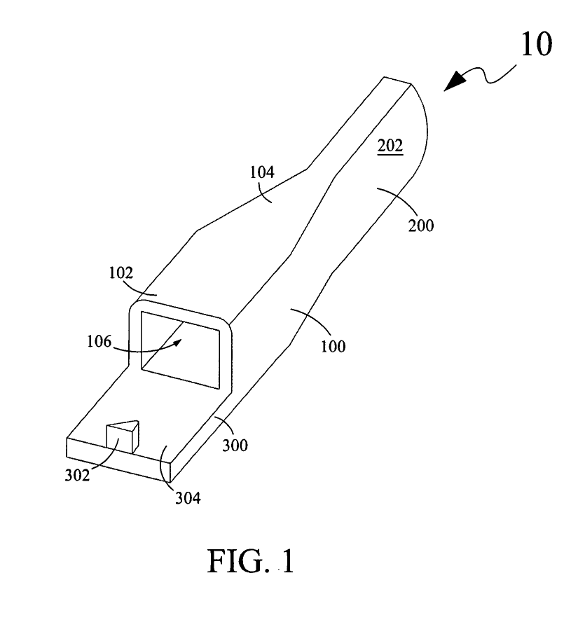

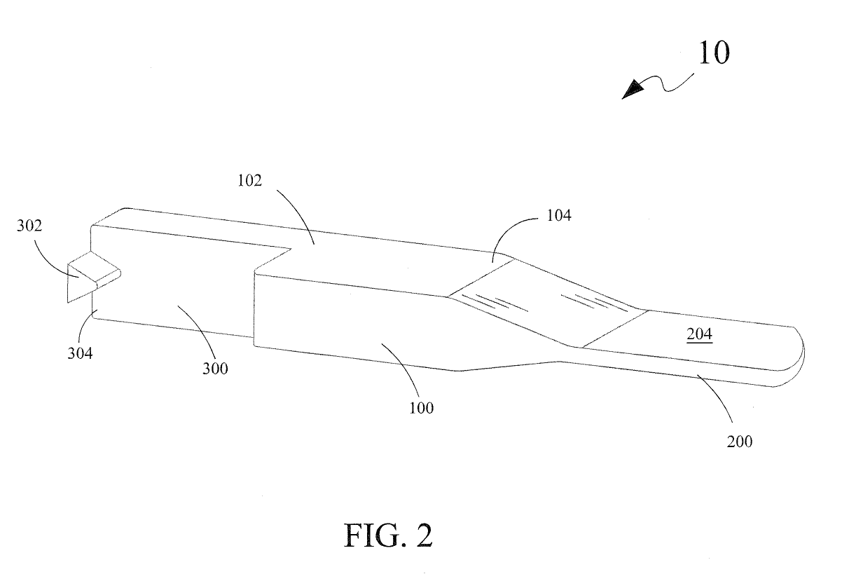

Referring to FIGS. 1 and 2, an embodiment of a device 10 is illustrated. More specifically, FIG. 1 illustrates a front perspective view of the device 10. The device 10 may include a body member 100. The body member 100 may include a first end portion 102, a second end portion 104 opposite to the first end portion 102, and a slot 106 configured in the first end portion 102.

Further, the device 10 may include a handle member 200 extending longitudinally from the second end portion 104 of the body member 100. In the embodiment shown in the drawings, the handle member 200 is an elongated and flattened rectangular structure, as shown in FIG. 2. However, the handle may have an alternative structure. The handle member 200 may include a first surface 202 and a second surface 204 opposite to the first surface 202.

The device 10 may also include a locking member 300 extending longitudinally from the first end portion 102 and in a direction opposite to the handle member 200. The locking member 300 may include a protrusion 302 positioned along a longitudinal axis of the locking member 300 and extending from an end portion 304 of the locking member 300.

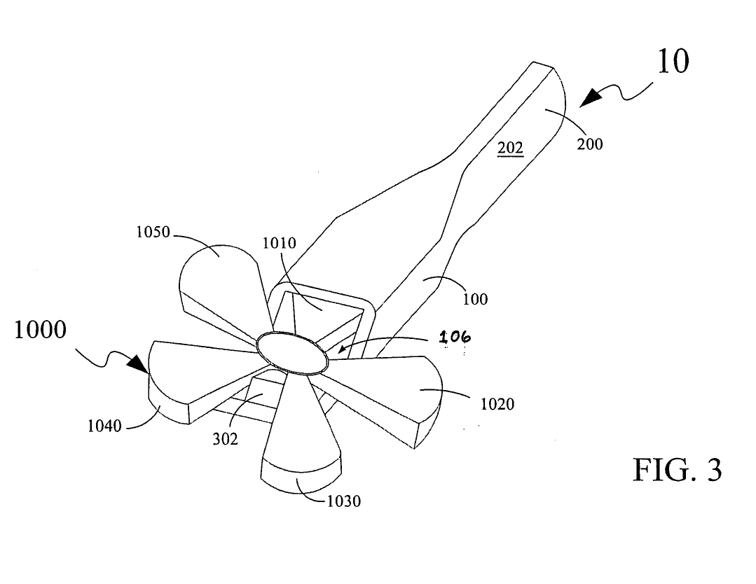

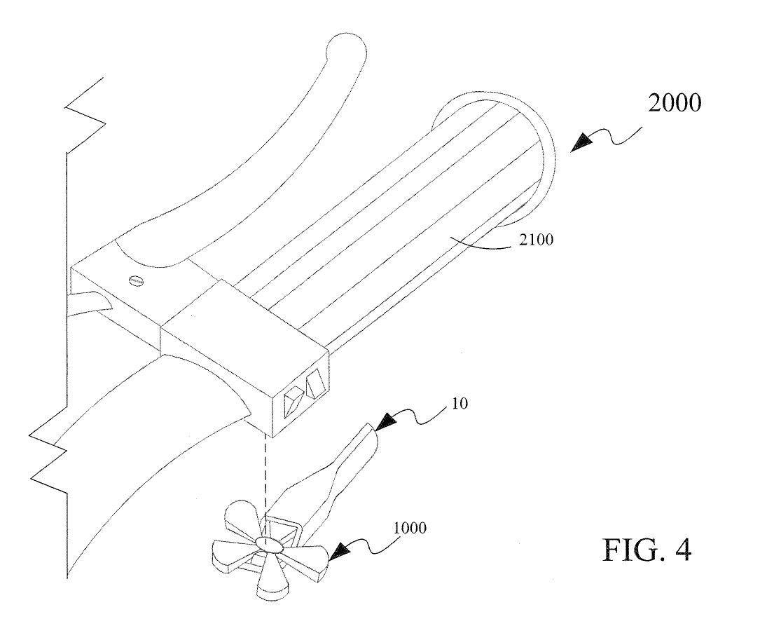

In use the device 10 may be removably attached to a motorcycle throttle lock (not numbered) of a motorcycle 2000, as shown in FIGS. 3 and 4. The motorcycle throttle lock may be attached to a hand grip throttle 2100 of the motorcycle 2000. The motorcycle throttle lock may include a lock screw 1000 having a plurality of arms such as arms 1010, 1020, 1030, 1040 and 1050. The body member may engage arm 1010 by receiving the arm in the slot 106. In addition, protrusion 302 may engage the motorcycle throttle lock by insertion of the protrusion into a space formed between adjacent ones of the throttle lock arms (for example, between the arm 1030 and the arm 1040) to form a snap fit.

Once the device 10 is attached on an arm of the lock screw 1000, the device 10 may be utilized for controlling the lock screw 1000 and in turn for operating the motorcycle throttle lock. More specifically, a motorcyclist (not shown) may push the first surface 202 of the handle member 200 in a first direction with a thumb (not shown) thereby moving the lock screw 1000 in a manner such that the motorcycle throttle lock resides in a first operational mode of a plurality of operational modes. In one embodiment, the cruise control is active in the first operational mode. The motorcyclist may move the first surface 202 of the handle member 200 without removing his or her hand from the hand grip throttle 2100. In the first position, the motorcycle throttle lock locks the hand grip throttle 2100 for the purpose of maintaining a steady throttle opening over an extended period of time. Once it is desired to release the motorcycle throttle lock, the second surface 204 of the handle member 200 is pushed with any of the fingers, such as a first finger, in a second direction substantially opposite the first direction, in a manner such that the motorcycle throttle lock resides in a second operational mode of the plurality of operational modes. When placed in the second operational mode, the motorcycle throttle lock releases the hand grip throttle 2100.

Further, the device 10 may easily be removed from the lock screw 1000 by pushing the protrusion 302 away from the space between the adjacent arms.

The device 10 may be made of any sturdy and durable material such as plastic material, metallic material, and the like. Further, the device 10 may be made in different sizes and shapes to fit various types of motorcycle throttle locks. It will be evident that the shape of the device 10 is set forth herein for purposes of illustration and that the present disclosure is not limited to the shape as disclosed.

Based on the forgoing description, a device for operating a motorcycle throttle lock, such as the device 10, may be beneficial for operating a motorcycle throttle lock with ease and in a user-friendly manner. The device may be removably attached to the motorcycle throttle lock and may be operable by the fingers of the motorcyclist's hand without the necessity of removing the hand from the hand. Further, the device acts as a paddle to facilitate operation of the motorcycle throttle lock, making the throttle wheel lock easily accessible and operable while riding the motorcycle even when the motorcyclist is wearing gloves.

The foregoing descriptions of specific embodiments of the present disclosure have been presented for purposes of illustration and description. They are not intended to be exhaustive or to limit the disclosure to the precise forms disclosed, and obviously many modifications and variations are possible in light of the above teaching. The embodiments were chosen and described in order to best explain the principles of the disclosure and its practical application, and thereby enable others skilled in the art to best utilize the disclosure and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present disclosure.

What is claimed is:

1. A device for operating a motorcycle throttle lock, the device comprising:
a body member configured for engaging a portion of the motorcycle throttle lock; and
a handle member extending from the body member;
wherein the handle member is configured for manipulation by a user to adjust the portion of the motorcycle throttle lock engaged with the body member to at least one of a first operational mode and a second operational mode.

2. The device of claim 1 wherein the body member defines a slot configured for receiving therein an arm of the motorcycle throttle lock to engage the arm.

3. The device of claim 1 further comprising a locking member extending from the body member, the locking member being configured for engaging a portion of the motorcycle throttle lock

4. The device of claim 3, wherein the motorcycle throttle lock includes at least a pair of adjacent arms, and wherein the locking member includes a protrusion extending therefrom, the protrusion being configured for positioning between the arms of the at least a pair of arms for engaging the portion of the motorcycle throttle lock.
